(19) United States
(12) Patent Application Publication
(10) Pub. No.: US 2025/0037651 A1
(43) Pub. Date: Jan. 30, 2025

(54) Pixel circuit and display system thereof

(71) Applicant: NOVATEK Microelectronics Corp., Hsin-Chu (TW)

(72) Inventor: Tsung-Hsien Lin, Tainan City (TW)

(73) Assignee: NOVATEK Microelectronics Corp., Hsin-Chu (TW)

(21) Appl. No.: 18/225,680

(22) Filed: Jul. 24, 2023

(51) Int. Cl. G09G 3/3233; G09G 3/3266; G09G 3/3275

(52) U.S. Cl. CPC G09G 3/3233; G09G 3/3266; G09G 3/3275; G09G 2330/021

(57) ABSTRACT

A pixel circuit of a display panel includes a light emitting device, a first transistor, a second transistor, a third transistor and a fourth transistor. The first transistor has a gate terminal, a drain terminal and a source terminal. The second transistor is coupled to the gate terminal of the first transistor. The third transistor is coupled to the source terminal of the first transistor. The fourth transistor, coupled to the drain terminal of the first transistor and the light emitting device, includes a gate terminal, a drain terminal and a source terminal. The gate terminal of the fourth transistor is coupled to a gate line on the display panel. The drain terminal of the fourth transistor is coupled to the gate line. The source terminal of the fourth transistor is coupled to the drain terminal of the first transistor.

### BACKGROUND OF THE INVENTION

### 1. Field of the Invention

The present invention relates to a pixel circuit of a display panel, and more particularly, to a structure of a pixel circuit of a display panel capable of canceling the offset of threshold voltage.

### 2. Description of the Prior Art

Among those next-generation display technologies, the micro organic light emitting diode (micro-OLED) panel has become important in recent years. Unlike conventional LED or OLED panels with their screens being built on a glass substrate, the screen of a micro-OLED panel is directly mounted to a silicon wafer. The silicon-based implementation can achieve a wide variety of benefits such as small size, light weight, low power consumption, high luminous efficiency, high contrast and high pixel density. With the above advantages, the micro-OLED panel is particularly suitable for augmented reality (AR) and virtual reality (VR) applications.

### SUMMARY OF THE INVENTION

It is therefore an objective of the present invention to provide a novel pixel circuit for an organic light emitting diode (OLED) panel, especially a micro-OLED panel.

An embodiment of the present invention discloses a pixel circuit of a display panel. The pixel circuit comprises a light emitting device, a first transistor, a second transistor, a third transistor and a fourth transistor. The first transistor has a gate terminal, a drain terminal and a source terminal. The second transistor is coupled to the gate terminal of the first transistor. The third transistor is coupled to the source terminal of the first transistor. The fourth transistor, coupled to the drain terminal of the first transistor and the light emitting device, comprises a gate terminal, a drain terminal and a source terminal. The gate terminal of the fourth transistor is coupled to a gate line on the display panel. The drain terminal of the fourth transistor is coupled to the gate line. The source terminal of the fourth transistor is coupled to the drain terminal of the first transistor.

Another embodiment of the present invention discloses a display system, which comprises a display panel, a source driver and a gate driver. The display panel comprises a plurality of pixels. The source driver has a plurality of channels, and each of the plurality of channels is coupled to a column of pixels among the plurality of pixels. The gate driver is coupled to a plurality of gate lines on the display panel, and each of the plurality of gate lines is coupled to a row of pixels among the plurality of pixels. Each of the plurality of pixels has a pixel circuit, which comprises a light emitting device, a first transistor, a second transistor, a third transistor and a fourth transistor. The first transistor has a gate terminal, a drain terminal and a source terminal. The second transistor is coupled to the gate terminal of the first transistor. The third transistor is coupled to the source terminal of the first transistor. The fourth transistor, coupled to the drain terminal of the first transistor and the light emitting device, comprises a gate terminal, a drain terminal and a source terminal. The gate terminal of the fourth transistor is coupled to a first gate line among the plurality of gate lines. The drain terminal of the fourth transistor is coupled to the first gate line. The source terminal of the fourth transistor is coupled to the drain terminal of the first transistor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIG. 2 is a schematic diagram of a pixel circuit according to an embodiment of the present invention.

FIG. 3 is a waveform diagram of related signals and voltages of the pixel circuit shown in FIG. 2.

FIGS. 4A-4E illustrate the operations of the pixel circuit in several phases.

FIG. 5 is a schematic diagram of another pixel circuit according to an embodiment of the present invention.

FIG. 6 is a waveform diagram of related signals and voltages of the pixel circuit shown in FIG. 5.

FIG. 7 is a schematic diagram of a circuit model of a row of pixel circuits in the initial phase.

FIGS. 8-11 are timing diagrams of the operations of multiple rows of pixels in a frame period according to embodiments of the present invention.

FIG. 12 is a schematic diagram of a further pixel circuit according to an embodiment of the present invention.

FIG. 13 is a waveform diagram of related signals and voltages of the pixel circuit shown in FIG. 12.

FIG. 14 is a schematic diagram of a pixel circuit according to an embodiment of the present invention.

### DETAILED DESCRIPTION

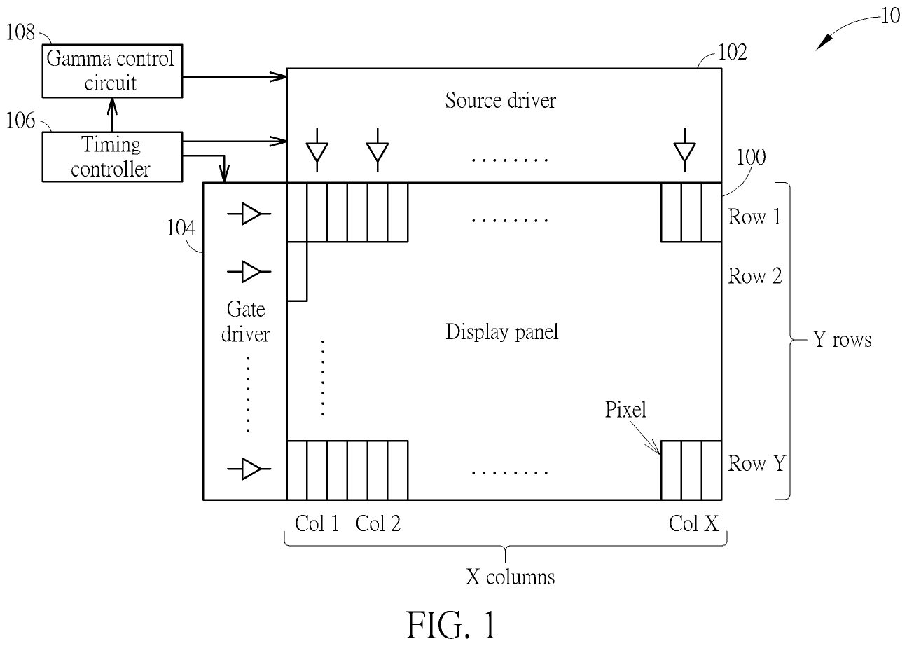

FIG. 1 is a schematic diagram of a display system 10 according to an embodiment of the present invention. The display system 10 includes a display panel 100, a source driver 102, a gate driver 104, a timing controller 106 and a gamma control circuit 108. The display panel 100 includes a plurality of pixels arranged as an array. For example, as shown in FIG. 1, the display panel 100 has Y rows and X columns of pixels, where X and Y may be any appropriate positive integers. In some embodiments, each pixel may include three subpixels, and each subpixel may be applied to show a specific color and have a pixel circuit composed of several transistors and capacitors and a light emitting device, where the light emitting device may be a light-emitting diode (LED) or an organic LED (OLED), but not limited herein.

The source driver 102 may include a plurality of channels. Each channel may be coupled to a column of pixels, or coupled to multiple columns of pixels through multiplexer control. The source driver 102 may provide data voltages and initial voltages for controlling the pixel circuit. Each channel of the source driver 102 may include a shift register, a digital-to-analog converter (DAC) and an output buffer. The detailed structure of the source driver 102 is well known by a skilled person, and will be omitted herein.

The gate driver 104 may also include a plurality of channels. Each channel may be coupled to one or more gate lines on the display panel 100, to supply gate control signals and/or emission control signals to the pixel circuit through the gate lines. Each gate line may connect a row of pixels on the display panel 100. In an embodiment, the gate driver 104 may be implemented in a gate-on-array (GOA) circuit. Each channel of the gate driver 104 may include a shift register and an output buffer. The detailed structure of the gate driver 104 is well known by a skilled person, and will be omitted herein.

The timing controller 106 may control the operations of the source driver 102 and the gate driver 104. More specifically, the timing controller 106 may serve as an image source to provide image data for the source driver 102, and thus the source driver 102 may convert the image data into the data voltages by referring to the gamma control circuit 108. The gamma control circuit 108 is capable of generating a plurality of gamma voltages to be selected by the source driver 102 for generating the data voltages based on the image data. Correspondingly, the timing controller 106 may control the operation timing of the gate driver 104, so that the gate driver 104 may output gate/emission control signals to scan a specific row of pixels to receive the corresponding data voltages in a display line period, allowing the LEDs/OLEDs in this row of pixels to emit light based on the data voltages.

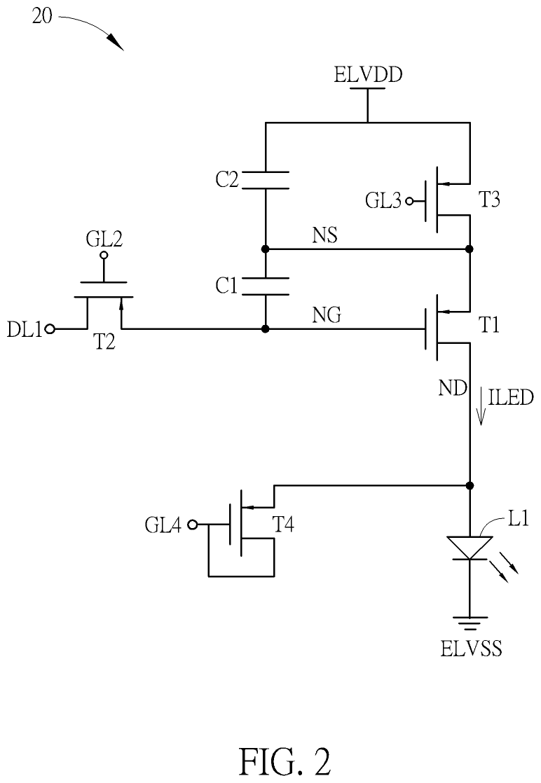

FIG. 2 is a schematic diagram of a pixel circuit 20 according to an embodiment of the present invention. The pixel circuit 20 includes 4 transistors T1-T4, 2 capacitors C1 and C2, and a light emitting device L1. The pixel circuit 20 may be operated by receiving a first power supply voltage ELVDD and a second power supply voltage ELVSS, where the power supply voltage ELVDD may be a positive voltage and the power supply voltage ELVSS may be a negative voltage or ground voltage. The pixel circuit 20 may be implemented in any pixel of the display panel 100 as shown in FIG. 1.

As shown in FIG. 2, the transistor T1 may be a driving transistor that outputs a driving current ILED for driving the light emitting device L1 to emit light. The transistors T2-T4 may serve as control switches for controlling the operations of the driving transistor T1 and the light emitting device L1 in different phases. These transistors T2-T4 may be deployed and controlled appropriately to cancel the deviations of the driving current ILED generated from the variations of the threshold voltage of the driving transistor T1. In this embodiment, the transistors T2, T3 and T4 may be operated by receiving control signals from different gate lines GL2, GL3 and GL4, respectively, where the gate lines GL2-GL4 are coupled to the gate driver and the corresponding control signals are received from the gate driver.

The capacitor C1 may be coupled between the gate terminal of the transistor T1 and the source terminal of the transistor T1, and the capacitor C2 may be coupled between the source terminal of the transistor T1 and a first power supply terminal that supplies the power supply voltage ELVDD. When the pixel circuit 20 receives the data voltage or the initial voltage, the voltage information may be stored in the capacitors C1 and/or C2. The capacitors C1 and/or C2 may also store the information of the threshold voltage of the transistor T1.

The transistor T2 is coupled between the gate terminal of the transistor T1 and a data line DL1, where the data line DL1 is further coupled to the source driver; hence, the transistor T2 may serve as a switch for receiving the data voltage and/or initial voltage from the source driver. In detail, a first terminal of the transistor T2 is coupled to the data line DL1 to receive the data voltage, a second terminal of the transistor T2 is coupled to the gate terminal of the transistor T1, and the gate terminal of the transistor T2 is coupled to the gate line GL2. The transistor T2 is responsible for controlling the pixel circuit 20 to receive the data voltage and the initial voltage.

The transistor T3 is coupled between the source terminal of the transistor T1 and the first power supply terminal that supplies the power supply voltage ELVDD, to serve as a switch for conducting the current flowing through the transistor T1. In detail, a first terminal of the transistor T3 is coupled to the source terminal of the transistor T1, a second terminal of the transistor T3 is coupled to the first power supply terminal, and the gate terminal of the transistor T3 is coupled to the gate line GL3. The transistor T3 is responsible for controlling the current path for reset and light emission.

The transistor T4 is coupled to the drain terminal of the transistor T1 and the light emitting device L1, to serve as a switch for resetting the light emitting device L1. In detail, the gate terminal and the drain terminal of the transistor T4 are coupled together, to be commonly coupled to the gate line GL4. The source terminal of the transistor T4 is coupled to the drain terminal of the transistor T1. The transistor T4 is responsible for controlling the reset of the light emitting device L1. In this embodiment, the gate terminal of the transistor T4 is connected to the drain terminal of the transistor T4, and these terminals are commonly coupled to the gate line GL4, to be further coupled to the gate driver.

In a general pixel circuit, the reset transistor for a light emitting device is usually connected to a power supply terminal for discharging; hence, the IR-drop on the power lines may cause a deviation on the reset behavior between different pixels. Such a deviation is requested to be eliminated in the back-end circuit or module, such that a great number of resources are necessary for solving this problem. In contrast, in the present invention, the reset transistor such as the transistor T4 in the pixel circuit 20 discharges through the gate line GL4 instead of the power supply terminal; hence, the IR-drop problem may be avoided and thus the back-end resources may be saved. In addition, the drain and gate terminals of the transistor T4 are commonly coupled to the same gate line GL4, and therefore the power supply terminal does not need to be connected to the transistor T4. This reduces the wire connections of the power supply terminal and simplifies the layout arrangement in each pixel circuit.

The light emitting device L1 is coupled between the drain terminal of the transistor T1 and a second power supply terminal that supplies the power supply voltage ELVSS. The light emitting device L1, which may emit light when driven by the driving current ILED received from the transistor T1, may be any device capable of emitting light by receiving currents, such as a LED or OLED.

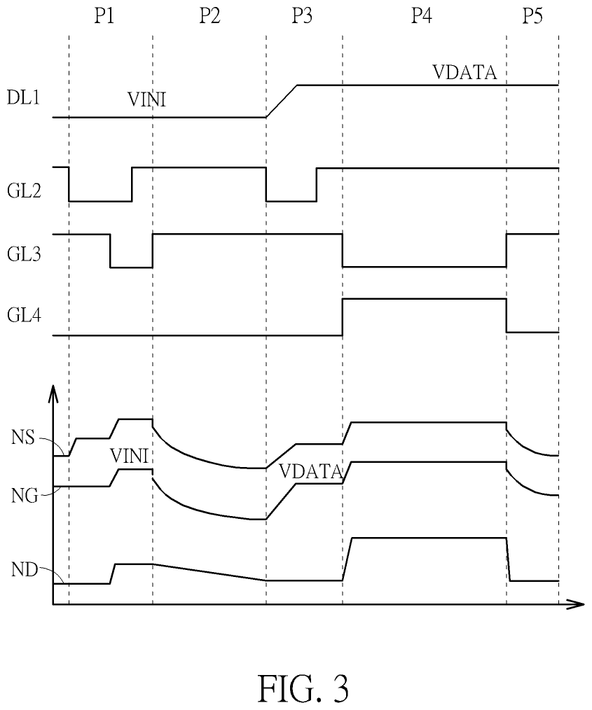

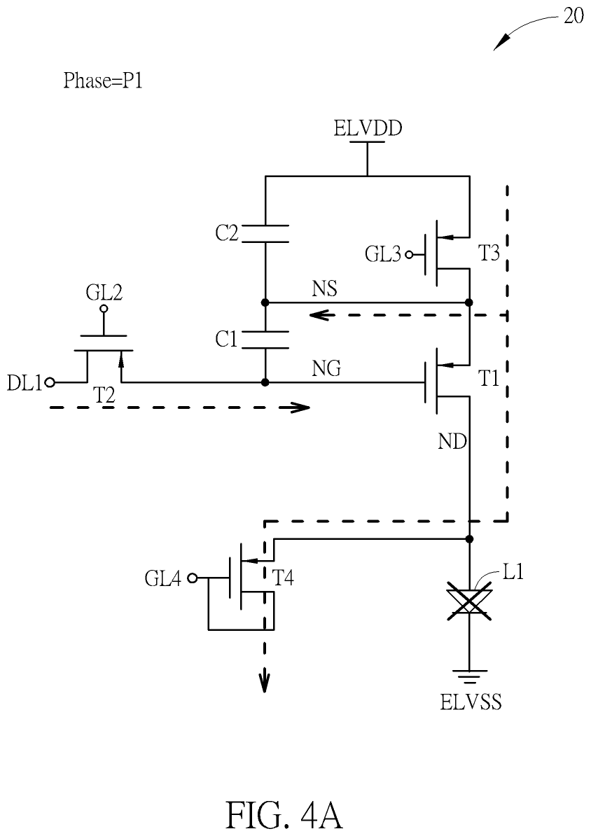

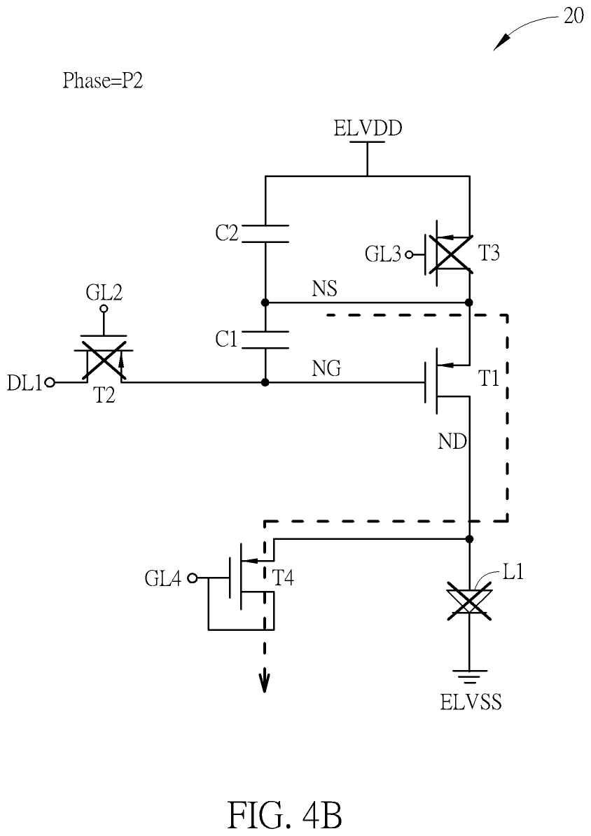

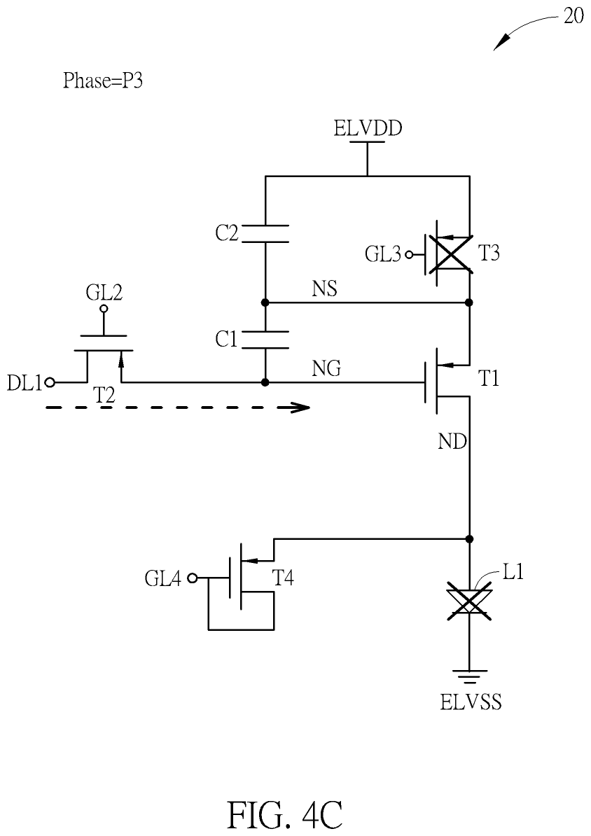

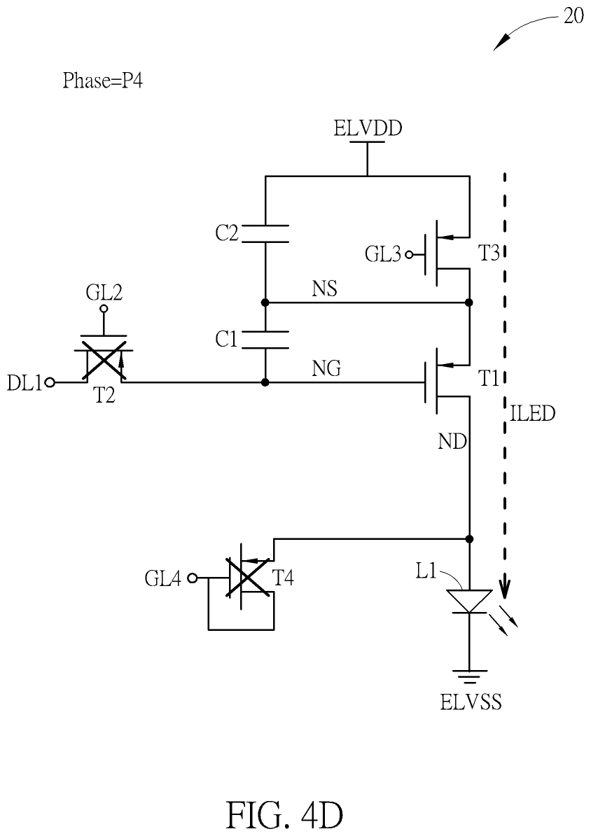

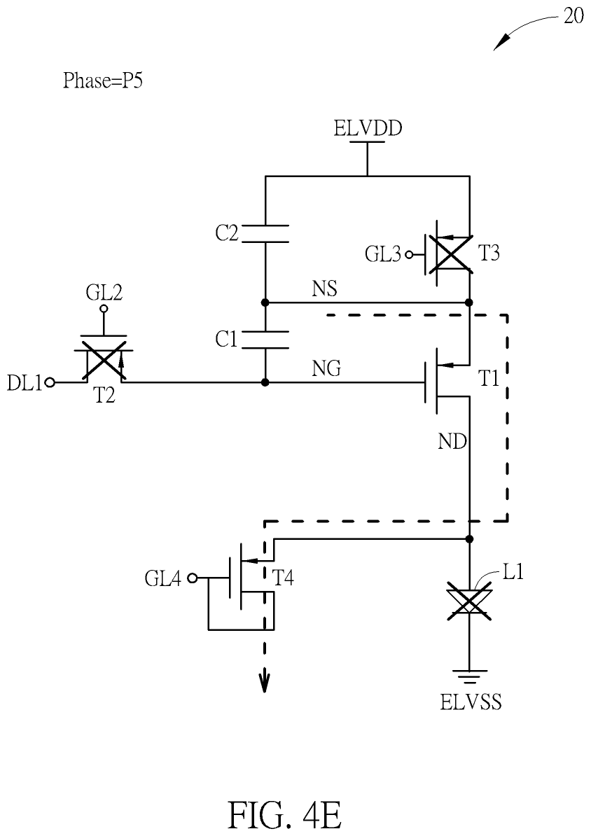

The operations of the pixel circuit 20 include several phases. FIG. 3 is a waveform diagram of related signals and voltages of the pixel circuit 20, where the waveforms of the signals on the data line DL1, the signals on the gate lines GL2-GL4, and the voltages on the nodes NS, NG and ND are shown. The nodes NS, NG and ND refer to the source terminal, gate terminal and drain terminal of the transistor T1, respectively. Note that in the pixel circuit 20, the transistors T2-T4 are PMOS transistors, and thus the signals in low level may turn on the corresponding transistors and in high level may turn off the corresponding transistors. FIG. 3 shows that the operations of the pixel circuit 20 have 5 phases P1-P5, which are detailed in FIGS. 4A-4E, respectively.

Referring to FIG. 4A along with FIG. 3, the phase P1 may be regarded as an initial phase (or called reset phase or pre-charge phase), where the transistor T2 is first turned on and then the transistor T3 is turned on, and the transistor T4 is always on in this phase. The pixel circuit 20 receives an initial voltage VINI from the data line DL1 when the transistor T2 is turned on. The initial voltage VINI may be written to the gate terminal of the transistor T1 to reset the electric charges at the gate terminal of the transistor T1 and stored in the capacitor C1. In addition, since the transistor T4 is turned on, the light emitting device L1 may be reset by discharging the electric charges of the light emitting device L1 through the transistor T4. The transistor T4 may pull low the anode voltage of the light emitting device L1 to prevent the light emitting device L1 from emitting unwanted light in the initial phase P1. As shown in FIG. 4A, the drain and gate terminals of the transistor T4 are coupled to the gate line GL4, and thus the discharge currents from the transistor T1 and/or the light emitting device L1 will flow to the gate line GL4 through the transistor T4.

Referring to FIG. 4B along with FIG. 3, the phase P2 may be regarded as a compensation phase, where the transistors T2 and T3 are turned off and the transistor T4 keeps on. In the phase P2, the transistor T1 performs self-discharging to allow the information of the threshold voltage to appear as the gate-to-source voltage of the transistor T1 (i.e., the voltage difference of the nodes NG and NS) to be stored in the capacitors C1 and C2. In addition, the source voltage falling to different levels may result in different magnitudes of body effect, and the information of the body effect may also be stored in the capacitors C1 and C2. Note that the pixel circuit 20 is contained in a small-size subpixel, and the body of the PMOS transistors T1-T4 should be coupled to the power supply terminal and thus the body effect is unavoidable.

Referring to FIG. 4C along with FIG. 3, the phase P3 may be regarded as a data writing phase (or called scan phase), where the transistor T2 is turned on, the transistor T4 keeps on, and the transistor T3 keeps off. In this phase, the data voltage VDATA is input from the data line DL1 to the gate terminal NG of the transistor T1 through the conducted transistor T2. Note that the information of the threshold voltage is stored in the capacitors C1 and C2, and the related influence may be canceled when the data voltage VDATA is input.

In this embodiment, the initial voltage VINI and the data voltage VDATA are both received from the data line DL1. Therefore, the transistor T2 may forward the initial voltage VINI to the transistor T1 in the initial phase P1 and forward the data voltage VDATA to the transistor T1 in the data writing phase P3.

Referring to FIG. 4D along with FIG. 3, the phase P4 may be regarded as an emission phase, where the transistors T2 and T4 are turned off and the transistor T3 is turned on. The conducted transistor T3 allows the driving current ILED to be forwarded to the light emitting device L1 to drive the light emitting device L1 to emit light. Since the data voltage VDATA (after canceling the offset caused by the threshold voltage) is stored in the capacitors C1 and C2, the driving current ILED may keep at its target level during the emission time.

Referring to FIG. 4E along with FIG. 3, the phase P5 may be regarded as an off phase, where the transistor T4 is turned on, the transistor T3 is turned off, and the transistor T2 keeps off. The phase P5 may be operated after the emission phase P4, where the transistor T1 outputs no driving current to the light emitting device L1 in the phase P5.

In several applications such as augmented reality (AR) or virtual reality (VR), the display panel is preferably operated with a lower emission duty cycle to mitigate the image sticking problem. In other words, the emission phase P4 may only occupy a smaller ratio of a display frame period or cycle. The additional time without any operation may be filled with the off phase P5 where no light emission is generated. The off phase P5 may last until the start of the next cycle. In the embodiment as shown in FIG. 4E, the status of the pixel circuit 20 in the phase P5 is identical to that in the phase P2.

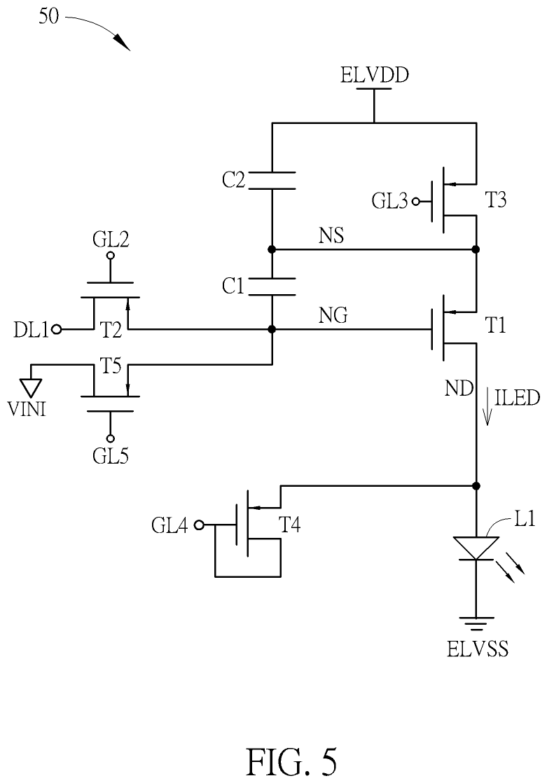

FIG. 5 is a schematic diagram of another pixel circuit 50 according to an embodiment of the present invention. The structure of the pixel circuit 50 is similar to the structure of the pixel circuit 20, so signals and elements having similar functions are denoted by the same symbols. The difference between the pixel circuit 50 and the pixel circuit 20 is that, the pixel circuit 50 further includes a transistor T5, which is coupled between the gate terminal of the transistor T1 and another input terminal, for receiving the initial voltage VINI and forwarding the initial voltage VINI to the transistor T1. The transistor T5 is coupled to another gate line GL5 for receiving a control signal. In the pixel circuit 50, the data voltage VDATA is received from the data line DL1 and forwarded through the transistor T2, and the initial voltage VINI is forwarded through the transistor T5.

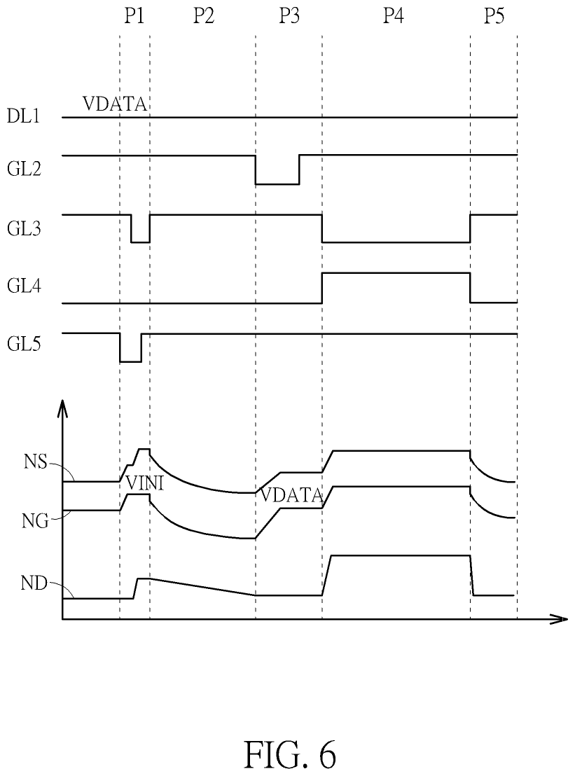

The waveforms associated with the pixel circuit 50 are illustrated in FIG. 6. Since the initial voltage VINI is supplied from another input terminal, the data line DL1 may always send the data voltage VDATA throughout the phases P1-P5. Correspondingly, the control signal on the gate line GL2 may turn on the transistor T2 only in the data writing phase P3. The control signal on the gate line GL5 may turn on the transistor T5 in the initial phase P1 for receiving the initial voltage VINI. Other operations of the pixel circuit 50 are similar to those of the pixel circuit 20 shown in FIGS. 3 and 4A-4E, and will not be repeated herein.

Based on the compensation scheme for the threshold voltage, the voltages stored in the capacitors C1 and C2 of the pixel circuit 20 or 50 in the initial phase P1 is requested to be accurate, and these stored voltages are influenced by the initial voltage VINI and the power supply voltage ELVDD. However, in the initial phase P1, each pixel has a steady current flowing to the gate line GL4 from the first power supply terminal. The current may result in an IR-drop on the power line and the gate line GL4 to cause a deviation of the power supply voltage ELVDD actually received by the pixel circuit.

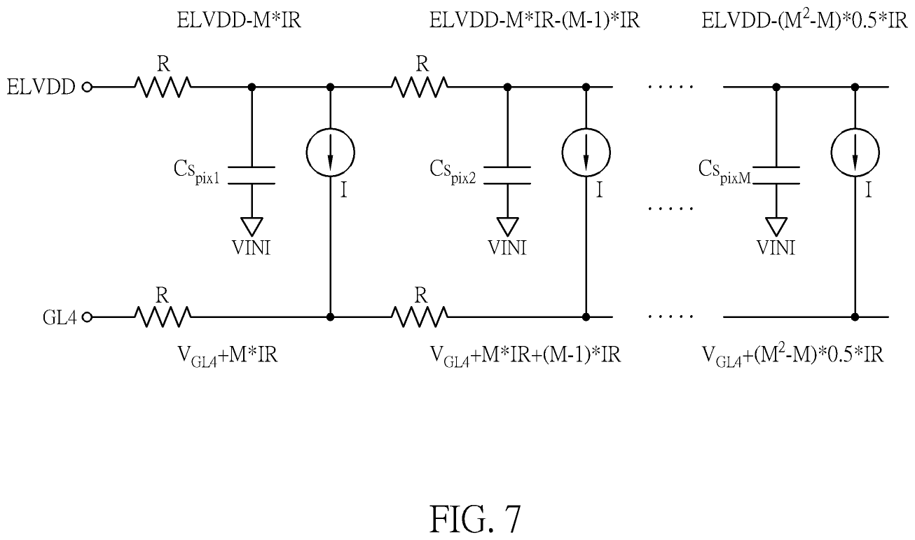

FIG. 7 is a schematic diagram of a circuit model of a row of pixel circuits in the initial phase, where there are M pixel circuits in this row and each pixel circuit has a storage capacitor Csₚᵢₓ₁-CS_{pixM}. Each of the storage capacitors CSₚᵢₓ₁-CS_{pixM} may be the capacitor C1 in the pixel circuit 20 or 50. It is supposed that the power line between every two adjacent pixel circuits and the gate line GL4 between every two adjacent pixel circuits have a parasitic resistor R, and that each pixel circuit passes a steady current I in the initial phase. In this embodiment, a power source may supply the power supply voltage ELVDD through the first power supply terminal and a gate driver may output a control voltage VGLA through the gate line GL4. The first (leftmost) pixel circuit may be closest to the power source and the gate driver, and the M-th (rightmost) pixel circuit may be farthest from the power source and the gate driver.

With the existence of the parasitic resistors R, the power supply voltage actually received by the pixel circuits may be slightly lower than ELVDD, and the voltage values received by different pixel circuits are different, as shown in FIG. 7. This is because the total current flowing from the power source to each pixel circuit may be different, depending on the distance between the pixel circuit and the power source, such that different pixel circuits may undergo different extents of IR-drop. This causes that the electric charges stored in the storage capacitors Csₚᵢₓ₁-CS_{pixM} cannot precisely reflect the initial voltage VINI, thereby resulting in an inconsistency of the reset/initial behavior, and this problem may be severe if there are more pixels included in the display panel under a high resolution application.

In addition, the control voltage actually received by the pixel circuits at the gate line GL4 may be slightly higher than VGL4, and the voltage values received by different pixel circuits are different, as shown in FIG. 7. Due to similar reasons, a pixel circuit farther from the gate driver may receive a higher control voltage from the gate line GL4. The control voltage may not be too high, or otherwise, the light emitting device of the pixel circuit may wrongly emit light in the initial phase. This problem may arise more probably with an increasing number of pixels included in the display panel under a high resolution application.

The problems of inconsistent power supply voltage ELVDD and control voltage VGL4 may be mitigated by decreasing the current I flowing through each pixel circuit in the initial phase. With a smaller initial current I, the pixel circuit may require a longer compensation time (e.g., longer compensation phase P2) to discharge the source voltage and the gate voltage of the driving transistor (e.g., the transistor T1) to their target levels. In other words, the increasing compensation time may effectively reduce the voltage offsets received by the pixel circuits and stored in the storage capacitors in the initial phase; or alternatively, may increase the feasible resolution of the display panel under the same tolerance of voltage offsets.

Referring back to FIG. 5, the implementation of applying different input transistors to receive the data voltage VDATA and the initial voltage VINI facilitates the increase of time length of the compensation phase P2.

More specifically, in the pixel circuit 20 as shown in FIG. 2, since the initial voltage VINI and the data voltage VDATA are received from the same data line DL1, the initial phase P1, the compensation phase P2 and the data writing phase P3 for a row of pixels are requested to be completed in an allocated display line period. In contrast, in the pixel circuit 50 as shown in FIG. 5, the initial voltage VINI and the data voltage VDATA are received from different terminals, and thus each row of pixels may start to perform pixel compensation and data writing without waiting for the previous row of pixels to complete data writing.

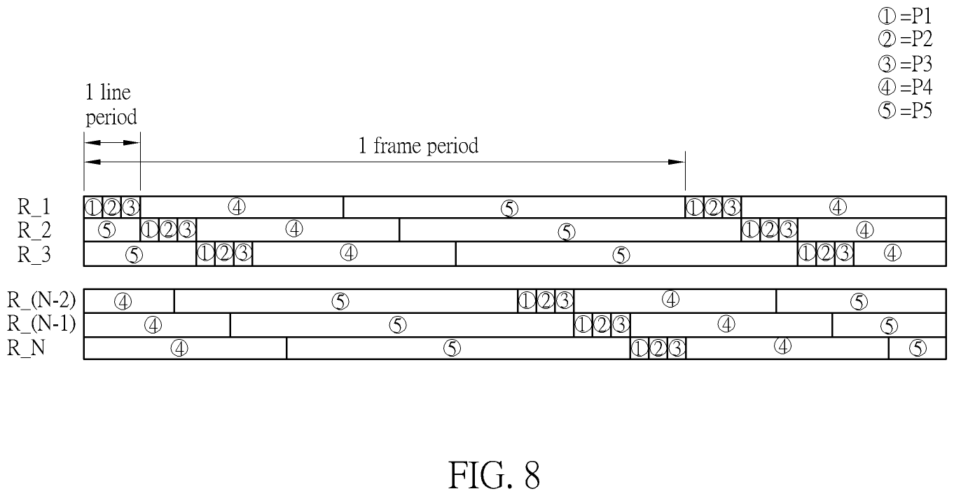

FIG. 8 is a timing diagram of the operations of multiple rows of pixels in a frame period according to an embodiment of the present invention, and this timing diagram may illustrate the operations of the pixel circuit 20. Supposing that there are N rows of pixels R_1-R_N, each row of pixels R_1-R_N are scanned in sequence to perform the operations of the phases P1-P5 sequentially. Note that the phase P1 is an initial phase for receiving the initial voltage VINI and the phase P3 is a data writing phase for receiving the display data VDATA. The phases P1-P3 with reception of the initial voltage VINI and the data voltage VDATA should be completed in one display line period (abbreviated as line period hereinafter). The phase P4 is an emission phase and the phase P5 is an off phase. The phases P4 and P5 may be allocated to remaining time in the frame period, with an appropriate emission duty cycle to realize the desired brightness.

In this embodiment, the initial voltage VINI and the data voltage VDATA may be received from the same data line; hence, the phases P1-P3 for each row of pixels R_1-R_N are performed in a respective line period. The data line (e.g., DL1) may forward the initial voltage VINI and then forward the data voltage VDATA to the target pixel in a specific row in each line period.

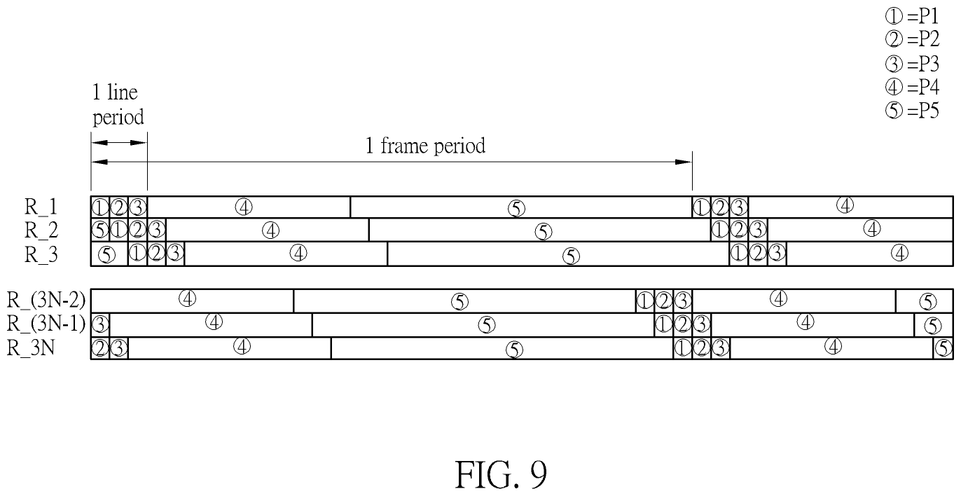

FIG. 9 a timing diagram of the operations of multiple rows of pixels in a frame period when the initial voltage VINI and the data voltage VDATA are received from different terminals according to an embodiment of the present invention, and this timing diagram may illustrate the operations of the pixel circuit 50. In this embodiment, the pixels in the second row R_2 may start the phase P1 to receive the initial voltage VINI when the pixels in the first row R_1 complete the phase P1. In other words, as for the pixels in a specific row R_n where n is an integer between 2 and N, the phase P1 of these pixels and the phase P2 of pixels in the previous row R_(n-1) may be performed at the same time. In addition, the pixels in the row R n may perform the phase P1 to receive the initial voltage VINI before the pixels in the previous row R_(n-1) perform the phase P3 to receive the data voltage VDATA. The timing of the phases P1 and P3 may be set more flexibly since the reception of the data voltage VDATA will not influence the reception of the initial voltage VINI.

As shown in FIG. 9, since the length of a line period is capable of containing the phase P1 of 3 rows of pixels, the same frame period length may be applied to scan tripled rows (i.e., 3N rows of pixels R_1-R_3N) under the same scanning speed, or the frame period may be shortened. In such a situation, the display panel may support tripled refresh rate or resolution.

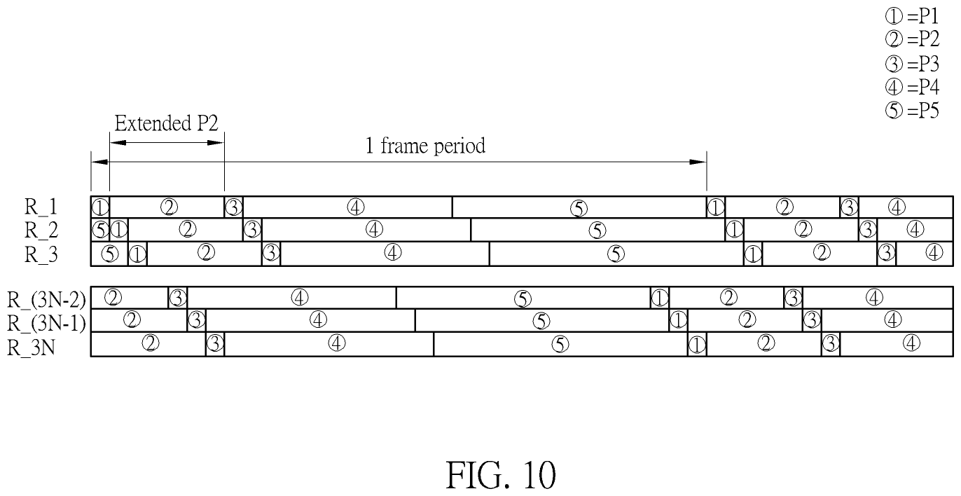

As mentioned above, the implementation of applying different input transistors (and input terminals) to receive the data voltage VDATA and the initial voltage VINI may increase the time length of the compensation phase P2, in order to reduce the voltage offsets resulting from the IR-drop on the power lines. The related implementation is shown in FIG. 10. Different from the implementation of FIG. 8 where the phases P1-P3 should be completed in a specific line period, in the embodiment shown in FIG. 10, the length of the compensation phase P2 may be extended arbitrarily without influencing the reception of the initial voltage VINI and the data voltage VDATA. The extended compensation phase P2 may reduce the voltage offsets received by the pixel by allowing the usage of a smaller initial current during the reset operation, and reduce the influence of time skew and improve the accuracy of compensation. In this embodiment, the refresh rate or resolution may also be tripled.

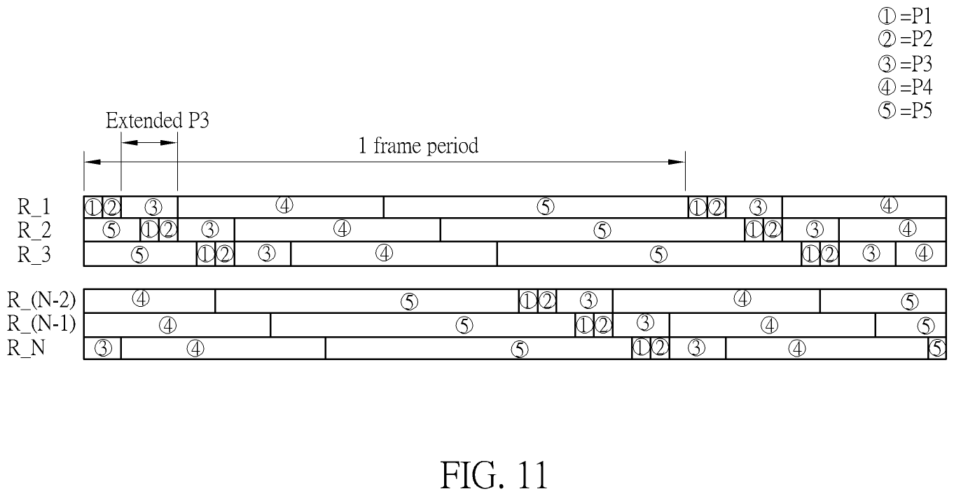

Note that the implementation of applying different input transistors (and input terminals) to receive the data voltage VDATA and the initial voltage VINI may provide higher flexibility that the data writing phase P3 may be extended to improve the accuracy of data reception, as shown in FIG. 11. In this embodiment, the length of the data writing phase P3 is extended without influencing the reception of the initial voltage VINI, and the refresh rate or resolution may be kept unchanged. The extended data writing phase P3 allows the data voltage VDATA actually received by each pixel to reach its target level more precisely.

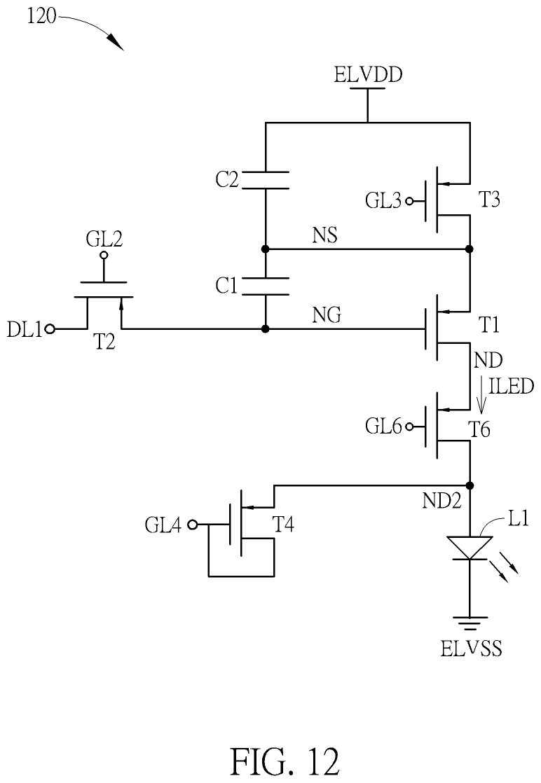

FIG. 12 is a schematic diagram of a further pixel circuit 120 according to an embodiment of the present invention. The structure of the pixel circuit 120 is similar to the structure of the pixel circuit 20, so signals and elements having similar functions are denoted by the same symbols. The difference between the pixel circuit 120 and the pixel circuit 20 is that, the pixel circuit 120 further includes a transistor T6, which is coupled between the transistor T1 and the light emitting device L1. More specifically, a terminal of the transistor T6 is coupled to the drain terminal of the transistor T1, and another terminal of the transistor T6 is coupled to the anode of the light emitting device L1 and the transistor T4. Therefore, the transistor T6 may serve as a switch for controlling the conducting path between the transistor T6 and the light emitting device L1.

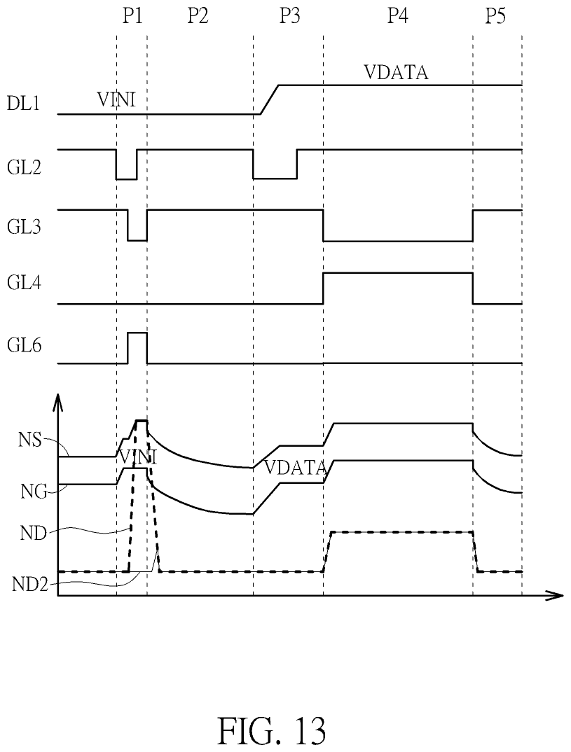

The waveforms associated with the pixel circuit 130 are illustrated in FIG. 13. The gate terminal of the transistor T6 is coupled to another gate line GL6, and the corresponding control signal may turn off the transistor T6 in the initial phase P1. As mentioned above, the steady current in the initial phase P1 may result in an IR-drop on the power line and the gate line GL4 to cause voltage offsets. The transistor T6 may cut off the current path, thereby preventing the steady current flowing from the first power supply terminal to the gate line GL4. The reduction of current may lead to a reduced power consumption of the display panel.

In this embodiment, the transistor T1 may still be reset by receiving the initial voltage VINI, and the light emitting device L1 may still be reset by using the transistor T4 to pull low its anode voltage. As shown in FIGS. 12 and 13, the voltage on the node ND2 refers to the anode voltage of the light emitting device L1, which keeps at a low level to prevent the light emitting device L1 from emitting light in the phase P1 even if the node ND is pulled high by the turn-on transistor T3. Other operations of the pixel circuit 120 are similar to those of the pixel circuit 20 shown in FIGS. 3 and 4A-4E, and will not be repeated herein.

Please note that the present invention aims at providing a novel pixel circuit for canceling the offset caused by the threshold voltage of the driving transistor. Those skilled in the art may make modifications and alterations accordingly. For example, in the above embodiments, the transistors in the pixel circuit are PMOS transistors; but in other embodiments, similar implementations may be realized by using NMOS transistors or combinations of PMOS and NMOS transistors, where the levels of the control signals and the initial voltage may be modified accordingly. In the embodiments provided in this disclosure, the structures of pixel circuits apply 2 capacitors C1 and C2, but the present invention is not limited thereto. In another embodiment, the capacitor C2 may be omitted while remaining the capacitor C1, so as to realize a single-capacitor pixel circuit structure. In addition, each of the above embodiments is applicable to a thin-film transistor (TFT) process to be implemented on a glass substrate of the display panel, and also applicable to a complementary metal-oxide semiconductor (CMOS) process to be implemented in an integrated circuit (IC). Further, the pixel circuit of the present invention may be applied to any self-luminous panel, which includes, but not limited to, an OLED panel, mini-LED panel, micro-LED panel, and micro-OLED panel.

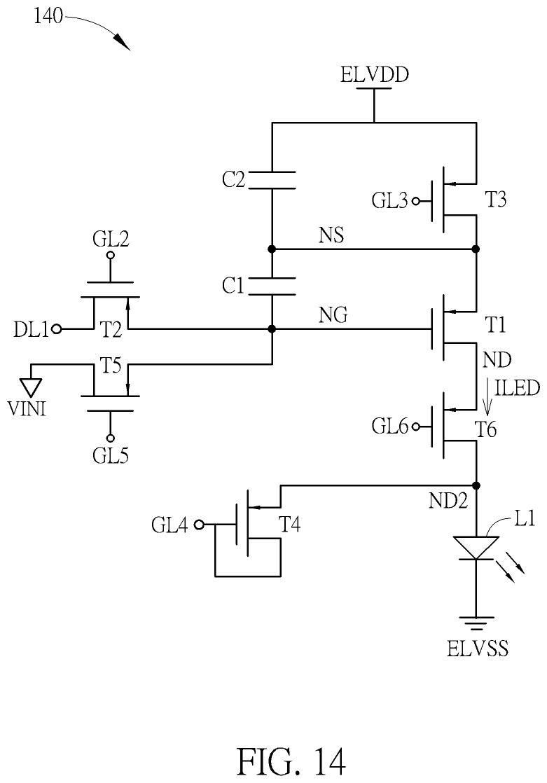

In another embodiment, the transistor dedicated to forward the initial voltage and the transistor for cutting off the steady current in the initial phase may be integrated in the same pixel circuit, as shown in FIG. 14. The pixel circuit 140 shown in FIG. 14 includes 6 transistors T1-T6, 2 capacitors C1-C2 and 1 light emitting device L1. The implementations and operations of the pixel circuit 140 are similar to those of the above embodiments, and will not be repeated herein.

To sum up, the present invention provides a pixel circuit of a display panel capable of canceling the offset generated from the threshold voltage of the driving transistor included in the pixel circuit. In the pixel circuit, the transistor for resetting the light emitting device is controlled by a control signal received from a gate line, which is coupled to the gate driver. As for this reset transistor, the gate terminal and the drain terminal are commonly coupled to the gate line, and thus the discharge is performed through the gate line instead of the ground or power supply terminal; that is, the initial current is discharged through the gate line. This saves the resources for deploying additional ground lines or power lines to be coupled to the reset transistor. In an embodiment, the pixel circuit includes an additional transistor for receiving the initial voltage, so that the initial voltage and the data voltage are received through different input terminals. This allows any of the operational phases to be extended, to provide higher flexibility for phase timing allocation to enhance the resolution, refresh rate and reliability of the display panel. In an embodiment, the pixel circuit includes another transistor for cutting off the current conducting path in the initial phase, thereby reducing the steady current and mitigating the IR-drop generated on the power line and/or gate line. This improves the preciseness of the electric charges stored in the storage capacitors during the initial operation.

Those skilled in the art will readily observe that numerous modifications and alterations of the device and method may be made while retaining the teachings of the invention. Accordingly, the above disclosure should be construed as limited only by the metes and bounds of the appended claims.

1. A pixel circuit of a display panel, comprising:
a light emitting device;
a first transistor, having a gate terminal, a drain terminal and a source terminal;
a second transistor, coupled to the gate terminal of the first transistor;
a third transistor, coupled to the source terminal of the first transistor; and
a fourth transistor, coupled to the drain terminal of the first transistor and the light emitting device, the fourth transistor comprising:
a gate terminal, coupled to a gate line on the display panel;
a drain terminal, coupled to the gate line; and
a source terminal, coupled to the drain terminal of the first transistor;
wherein a discharge current from the fourth transistor flows to a gate driver through the gate line;
wherein the pixel circuit operates in an off phase after an emission phase, wherein the first transistor outputs no driving current to the light emitting device in the off phase, and the off phase lasts until a start of a next initialization phase.

2. The pixel circuit of claim 1, further comprising:
a first capacitor, coupled between the gate terminal of the first transistor and the source terminal of the first transistor; and
a second capacitor, coupled between the source terminal of the first transistor and a first power supply terminal.

3. The pixel circuit of claim 1, wherein the light emitting device is coupled between the drain terminal of the first transistor and a second power supply terminal.

4. The pixel circuit of claim 1, wherein the fourth transistor resets the light emitting device in an initial phase.

5. The pixel circuit of claim 1, wherein the gate terminal of the fourth transistor is connected to the drain terminal of the fourth transistor.

6. The pixel circuit of claim 1, wherein the discharge current flows to the gate driver in an initial phase.

7. The pixel circuit of claim 1, wherein the second transistor forwards an initial voltage to the first transistor in an initial phase, and forwards a data voltage to the first transistor in a data writing phase.

8. The pixel circuit of claim 1, wherein the second transistor forwards a data voltage to the first transistor, and the pixel circuit further comprises:
a fifth transistor, coupled to the gate terminal of the first transistor, to forward an initial voltage to the first transistor.

9. (canceled)

10. The pixel circuit of claim 1, further comprising:
a sixth transistor, coupled between the first transistor and the light emitting device, the sixth transistor comprising:
a first terminal, coupled to the drain terminal of the first transistor; and
a second terminal, coupled to the light emitting device.

11. The pixel circuit of claim 10, wherein the sixth transistor is turned off in the initial phase.

12. The pixel circuit of claim 1, wherein the display panel comprises a plurality of rows of pixels scanned by receiving an initial voltage in an initial phase and then receiving a data voltage in a data writing phase, and a second row of pixels among the plurality of rows of pixels are scanned after a first row of pixels among the plurality of rows of pixels in a frame period;
wherein the second row of pixels receive the initial voltage before the first row of pixels receive the data voltage in the frame period.

13. The pixel circuit of claim 1, wherein the gate line connects a row of pixels on the display panel.

14. A display system, comprising:
a display panel comprising a plurality of pixels;
a source driver having a plurality of channels each coupled to a column of pixels among the plurality of pixels; and
a gate driver coupled to a plurality of gate lines on the display panel, each of the plurality of gate lines being coupled to a row of pixels among the plurality of pixels;
wherein each of the plurality of pixels has a pixel circuit, which comprises:
a light emitting device;
a first transistor, having a gate terminal, a drain terminal and a source terminal;
a second transistor, coupled to the gate terminal of the first transistor;
a third transistor, coupled to the source terminal of the first transistor; and
a fourth transistor, coupled to the drain terminal of the first transistor and the light emitting device, the fourth transistor comprising:
a gate terminal, coupled to a first gate line among the plurality of gate lines;
a drain terminal, coupled to the first gate line; and
a source terminal, coupled to the drain terminal of the first transistor;
wherein a discharge current from the fourth transistor flows to the gate driver through the first gate line;
wherein the pixel circuit operates in an off phase after an emission phase, wherein the first transistor outputs no driving current to the light emitting device in the off phase, and the off phase lasts until a start of a next initialization phase.

15. The display system of claim 14, wherein the pixel circuit further comprises:
a first capacitor, coupled between the gate terminal of the first transistor and the source terminal of the first transistor; and
a second capacitor, coupled between the source terminal of the first transistor and a first power supply terminal.

16. The display system of claim 14, wherein the light emitting device is coupled between the drain terminal of the first transistor and a second power supply terminal.

17. The display system of claim 14, wherein the fourth transistor resets the light emitting device in an initial phase.

18. The display system of claim 14, wherein the gate terminal of the fourth transistor is connected to the drain terminal of the fourth transistor.

19. The display system of claim 14, wherein the discharge current flows to the gate driver in an initial phase.

20. The display system of claim 14, wherein the second transistor forwards an initial voltage to the first transistor in an initial phase, and forwards a data voltage to the first transistor in a data writing phase.

21. The display system of claim 14, wherein the second transistor forwards a data voltage to the first transistor, and the pixel circuit further comprises:
a fifth transistor, coupled to the gate terminal of the first transistor, to forward an initial voltage to the first transistor.

22. (canceled)

23. The display system of claim 14, wherein the pixel circuit further comprises:
a sixth transistor, coupled between the first transistor and the light emitting device, the sixth transistor comprising:
a first terminal, coupled to the drain terminal of the first transistor; and
a second terminal, coupled to the light emitting device.

24. The display system of claim 23, wherein the sixth transistor is turned off in the initial phase.

25. The display system of claim 14, wherein the plurality of pixels comprise a plurality of rows of pixels scanned by receiving an initial voltage in an initial phase and then receiving a data voltage in a data writing phase, and a second row of pixels among the plurality of rows of pixels are scanned after a first row of pixels among the plurality of rows of pixels in a frame period;
wherein the second row of pixels receive the initial voltage before the first row of pixels receive the data voltage in the frame period.
